(19) United States
(12) Patent Application Publication
(10) Pub. No.: US 2020/0198278 A1
(43) Pub. Date: Jun. 25, 2020

(54) Sole and Method for Preparing Same

(71) Applicant: Zhongshan Cheng Shing Plastic Co., Ltd., Zhongshan City (CN)

(72) Inventor: Yunshun Li, Zhongshan City (CN)

(21) Appl. No.: 16/594,861

(22) Filed: Oct. 7, 2019

(30) Foreign Application Priority Data
Dec. 21, 2018 (CN) 201811579444.X

(51) Int. Cl. B29D 35/14; B29C 33/64; A43B 13/02; B29C 33/58

(52) U.S. Cl. CPC B29D 35/142; B29C 33/64; B29K 2075/02; B29C 33/58; A43B 13/02

(57) ABSTRACT

A sole having a foam layer and a film layer. The foam layer is formed by mixing material A and material B. After the release agent is sprayed on the film layer, the raw material is filled in the cavity of the mold for baking insulation. The AB mixed raw material has emulsification reaction and is foamed, and the mold is filled and prepared. The present invention has the beneficial effects that: the sole according is mainly suitable for the sole of a slipper, lighter and more comfortable; a film is formed on the outer surface of the foam layer, so that the surface of the finished product is smoother, more beautiful, and higher in yield rate; in the preparation process, a shaking mode technology is adopted to reduce the shortage of materials and dark bubbles in the product and also reduce the amount of bubbles in the product.

### CROSS REFERENCE TO RELATED APPLICATION

This application takes priority from and claims the benefit of Chinese Patent Application No. 201811579444.X filed on Dec. 21, 2018, the contents of which are herein incorporated by reference.

### BACKGROUND OF THE INVENTION

### Field of the Invention

The present invention belongs to the technical field of daily necessities, and in particular relates to a sole and a method for preparing the same.

### Description of the Related Art

Generally, the material of soles should be wear-resistant, water-resistant, oil-resistant, heat-resistant, pressure-resistant, impact-resistant, elastic, easy to be fit for the foot type, not easy to change after being sized, heat insulated, easy to absorb moisture, etc. Therefore, the sole is mainly made of natural bottom leather, bamboo, wood or synthetic rubber, plastic, rubber and plastic combined material, recycled leather, elastic cardboard, etc.

A slipper is a special type of shoes that are generally used indoors. Therefore, it is also required that it is more convenient, lighter and more comfortable to wear and take off.

However, the sole molding technology of the slippers is not good, the sole is easy to deform, the surface has uneven holes, and it is not comfortable enough to wear.

### SUMMARY OF THE INVENTION

In order to solve the problems existing in the prior art, the present invention provides a sole and a method for preparing the same. The sole has the characteristics that it is light in weight, comfortable to wear, etc. The method for preparing the same is unique, the molding technology is good, and the defective rate is low.

It is an object of the present invention to provide a sole.

It is another object of the present invention to provide a method for preparing the above sole.

According to the sole of a specific embodiment of the present invention, the sole comprises a foam layer and a film layer wrapped around an outer surface of the foam layer, the film layer has a thickness of 0.05-0.15 mm; the foam layer is prepared from the following raw material, the raw material comprises material A and material B, the material A comprises, in parts by weight: 90-95% of polyester polyol mixture; 5-10% of chain extender; 0.2-0.8% of foam stabilizer and 1-3% of foaming agent; the material B comprises, in parts by weight: 50-75% of MDI; 5-10% of liquefied MDI; 10-30% of polyester polyol and 10-20% of polyether polyol.

According to the sole of a specific embodiment of the present invention, the foam stabilizer is active polyether modified silicone oil; and the foaming agent is dicyandiamide.

According to the sole of a specific embodiment of the present invention, the raw material of the film layer comprises a polyurethane resin, a toner and fast drying water, and the film layer has a thickness of 0.1 mm The raw material of the film layer may also be other sprayable material which forms a film without affecting the performance of the foam layer, or is directly adsorbed on the surface of the mold by a film; the thickness of the film layer is 0.1 mm, or any thickness in which the film layer is neither broken nor affects the comfort of the foam layer.

According to the method for preparing a sole of a specific embodiment of the present invention, the method comprising the steps of:

(1) cleaning the mold and cleaning the mold from the inside to the outside;

(2) spraying the release agent, after mixing and diluting an aqueous release agent with water, spraying the inner surface of the mold; then drying the release agent, and then wiping the surface with a clean cloth to form the inner surface of the mold of the sprayed release agent;

(3) spraying the mold, spraying the mixed raw material of the film layer to the inner surface of the mold of the sprayed release agent formed in the step (2), and naturally forming a mold after mixing and drying the raw material;

(4) injecting the raw material, uniformly mixing the material A and the material B of the foam layer by a filling machine according to a set ratio, and then injecting it into the mold;

(5) shaking the mold, covering the upper cover of the mold gently and quickly, and locking the mold with a pressure handle; and then gently shaking the mold so that the raw material uniformly covers the inner cavity of the mold;

(6) baking, putting the mold shaken in the step (5) into the baking area for baking, performing emulsified reaction until the foaming molding, releasing the pressure handle, opening the upper cover, and taking out the finished product for trimming

According to the method for preparing a sole of a specific embodiment of the present invention, in the step (2), the aqueous release agent is a mixture of 95 wt % of silicon germanium resin emulsion and 5 wt % of water. The silicon germanium resin emulsion is an emulsion type silicone resin. The aqueous release agent made of the silicon germanium resin emulsion makes it easier and more convenient to release the mold, it is less likely to stick, and the product surface is smoother.

According to the method for preparing a sole of a specific embodiment of the present invention, in the step (2), the ratio of the added amount of the aqueous release agent to the water is 15:100, and the dried aqueous release agent has a thickness of 0.05-0.1 mm.

According to the method for preparing a sole of a specific embodiment of the present invention, in the step (3), the spray gun is adjusted into an atomizing shape when spraying, the spray gun mouth is aligned with the upper mold and the lower mold of the mold and sprays uniformly at a distance of 15-20 cm from the mold along the shape of the mold so that every corner of the mold can be uniformly sprayed. The main purpose of spraying the mold is to form a film on the surface of the mold so that this film covers the outside of the product, shielding the pinholes and current ripples generated by the surface of the product, increasing the yield rate and reducing the cost. When spraying, the film has a thickness of 0.1 mm so as to form a film, so that it is easy for the inside solvent to dry. If the release agent is sprayed too thickly, the solvent is not volatile, and it is not easy for the release agent to dry, which will damage the product and cause the surface of the product to be rotten; therefore, the release agent must be kept completely dry before entering the next process.

According to the method for preparing a sole of a specific embodiment of the present invention, in the step (4), prior to the injection, a mold foot is added to the toe cap of the mold to be raised by 5-10 cm so that the shoe mold has a high toe cap and a low heel and the bottom surface of the shoe mold is formed as a bevel for injection, and the volume of the raw material after being injected accounts for about ⅓-½ of the volume of the mold cavity.

According to the method for preparing a sole of a specific embodiment of the present invention, in the step (4), after being uniformly mixed by a filling machine according to a set ratio, the material A and the material B of the foam layer are injected into the mold; according to different weights of yardage of each mold, material is filled according to the key in which different durations of material filling are set on the filling machine correspondingly, wherein the material is filled in such a way that the material is taken from the middle of the cavity of the lower mold of the shoe mold and is fed to the toe cap along the center line of the cavity of the mold; while the material is injected, material is fed in the mold and the raw material injected into the mold is uniformly coated on the bottom and the periphery of the upper cavity and the lower cavity with a brush to cover the entire surface of the cavity of the mold.

According to the method for preparing a sole of a specific embodiment of the present invention, in the step (4), before the material A and the material B are mixed, a front stage catalyst, a latter stage catalyst, water and a hardener are added first and then are uniformly mixed to form mixed material A, and the mixed material A is kept at 38° C. for later use; and the material B is kept at 40° C.

According to the method for preparing a sole of a specific embodiment of the present invention, in the step (4), the ratio of the added amount of the material A to the material B is 100:100.

The time from the start of mixing of the material A and the material B to the discharge from the discharging port is not more than 1 second. The material A and the material B are introduced into a stirring chamber of a filling machine head from the two material cylinders using different pipelines by a pressure pump, respectively, uniformly stirred for 0.3-0.5 seconds using a stirring blade rotating at a high speed in the stirring chamber, and then injected rapidly into the mold from the discharging port; after the two raw materials A and B are mixed, the two raw materials are controlled by the catalyst in the material A, the reaction time is generally about 8-9 seconds, the total time from the mixing and stirring of the two raw materials into the stirring chamber to the discharge from the discharging port is more than 1 second. Therefore, the material A and the material B will not result in reaction in the whole stirring process.

According to the method for preparing a sole of a specific embodiment of the present invention, in the step (5), the mold is shaken in such a way as to invert the mold to the left or right by 180°, so that the lower mold and the upper cover are inverted and then placed statically for 1-2 seconds so that the material injected in the lower mold flows to the upper cover and then returns to position in order to reduce the shortage of materials and dark bubbles in the product; and then erect the front end of the mold so that the toe cap is facing upwards and the heel is facing downwards so as to form 90° with the horizontal plane for inversion of 3-4 seconds, so that the raw material injected to the toe cap better flows to the heel and then returns to position in order to reduce the amount of bubbles in the product.

According to the method for preparing a sole of a specific embodiment of the present invention, in the step (6), the baking time is 6-7 minutes; and the baking temperature is 80-90° C.

The polyester polyol comprises conventional polyester polyol, polycaprolactone polyol and polycarbonate diol which contain ester groups or carbonate groups. The polyester polyol mixture in the present invention is a mixture comprising polyester polyol, polycaprolactone polyol and polycarbonate diol. The polyester polyol of the present invention refers to polyester polyol obtained by a polycondensation reaction of dicarboxylic acid and diol.

The polyether polyol is an oligomer having a main chain containing an ether bond (—ROR—) and a terminal group or a pendant group containing more than 2 hydroxyl groups (—OH); the polyether polyol is formed by ring-opening polymerization of an oxidized olefin under the action of a catalyst with a low molecular weight polyol, a polyamine or an active hydrogen-containing compound as a starter.

The chain extender, also known as a chain growing agent, is a substance which is capable of reacting with a functional group on a linear polymer chain to expand its molecular chain and increase its molecular weight. It is often used to improve the mechanical properties and process properties of polyurethane, polyester and other products. It is very important for the synthesis of polyurethane adhesives and sealants, directly affecting the mechanical properties and process properties of the products. The main component of the chain extender of the present invention is a diamine low molecular compound.

The foam stabilizer is a surfactant which is capable of increasing the solubility of each component and plays the role of emulsifying the foam material, stabilizing the foam and regulating the cells. An important role of the foam stabilizer is to disperse the polyurea and increase the compatibility of the polyurea with the foam matrix; the foam stabilizer used currently is mostly a polyether modified silicone surfactant, and its main structure is a polysilane-monooxyalkylene block copolymer.

MDI, also known as diphenylmethane diisocyanate, is a polyurethane material synthesized from isocyanate and polyol and its complexing additives. MDI is unique among many synthetic materials due to its excellent performance, variety and wide application, and has become one of the fastest growing materials available today. Primary products are widely used in polyurethane coatings, and are also used in waterproof material, sealing material, ceramic material, and the like.

Liquefied MDI is also known as modified MDI. The liquefied MDI according to the present invention is to blend TDI in MDI to form a mixed diisocyanate with a low freezing point or introduce a carbamic acid ester or carbodiimide group in 4,4′-MDI to obtain a liquid MDI modifier.

The polyether modified silicone oil is a unique silicone nonionic surfactant which is obtained by graft copolymerization of polyether and dimethylsiloxane.

Compared with the prior art, the present invention has the following beneficial effects:

(1) the sole according to the present invention is mainly suitable for the sole of a slipper, lighter and more comfortable;

(2) a film is formed on the outer surface of the foam layer, shielding the pinholes and current ripples generated by the surface of the foam layer, so that the surface of the finished product is smoother, more beautiful, and higher in yield rate;

(3) in order to reduce the pinholes on the surface of the product, prior to the injection, a mold foot is added to the toe cap of the mold to be raised by 5-10 cm so that the bottom surface of the horizontal shoe is formed as a bevel with a high front part and a low back part, the impact of the raw material to the mold surface is reduced when the raw material is injected, it is easy for the raw material ejected from the front to flow down, and the raw material ejected from the front and the back will not generate bubbles due to the impact;

(4) in order to make the sole mold better and the cells more uniform, while the material is injected, material is fed in the mold and the raw material injected into the mold is uniformly coated on the bottom and the periphery of the upper cavity and the lower cavity with a brush to cover the entire surface of the cavity of the mold;

(5) in the preparation process, a shaking mode technology is adopted to reduce the shortage of materials and dark bubbles in the product and also reduce the amount of bubbles in the product;

(6) in the production of this patent, the mold closing line is a three-opening mold opening the mold in the middle, and the other PUs on the market are mostly lines opening and closing at the upper mold or the lower mold.

### DETAILED DESCRIPTION OF THE SEVERAL EMBODIMENTS

In order to make the objects, technical solutions and advantages of the present invention more clear, the technical solutions of the present invention will be described in detail below. It is apparent that the described embodiments are only a part of the embodiments of the present invention, rather than all of the embodiments. All other embodiments obtained by those skilled in the art based on the embodiments of the present invention without creative efforts are within the scope of protection of the present invention.

### Embodiment 1

The present embodiment provides a sole comprising a foam layer and a film layer wrapped around an outer surface of the foam layer, the film layer has a thickness of 0.1 mm; the foam layer is prepared from the following raw material, the raw material comprises material A and material B, the material A comprises, in parts by weight: 92% of polyester polyol mixture; 6% of chain extender; 0.6% of foam stabilizer and 1.4% of foaming agent; the material B comprises, in parts by weight: 60% of MDI; 8% of liquefied MDI; 20% of polyester polyol and 12% of polyether polyol. The above raw materials used in this embodiment are purchased from Xuchuan Chemical Co., Ltd.

The method for preparing a sole comprises the steps of:

(1) cleaning the mold and cleaning the mold from the inside to the outside;

(2) spraying the release agent, after mixing and diluting an aqueous release agent with water at a weight ratio of 15:100, spraying the inner surface of the mold; then drying the release agent, and then wiping the surface with a clean cloth to form the inner surface of the mold of the sprayed release agent; the aqueous release agent used in this embodiment is purchased from Weichuang Technology Co., Ltd., with the model number 1098;

(3) spraying the mold, spraying the mixed raw material of the film layer to the inner surface of the mold of the sprayed release agent formed in the step (2), and naturally forming a mold after mixing and drying the raw material; the raw material of the film layer used in the embodiment is purchased from Weichuang Technology Co., Ltd., with the model number is 501;

(4) injecting the raw material, uniformly mixing the material A and the material B of the foam layer by a filling machine according to a set ratio, and then injecting it into the mold; according to different weights of yardage of each mold, filling material according to the key in which different durations of material filling are set on the filling machine correspondingly, wherein the material is filled in such a way that the material is taken from the middle of the cavity of the lower mold of the shoe mold and is fed to the toe cap along the center line of the cavity of the mold;

(5) shaking the mold, covering the upper cover of the mold gently and quickly, and locking the mold with a pressure handle; then inverting and placing statically the mold for 1 seconds so that the raw material injected in the lower mold flows to the upper mold and then returns to position; and the toe cap of the mold facing upwards so as to form 90° with the horizontal plane for inversion of 3 seconds and then returning to position;

(6) baking, putting the mold shaken in the step (5) into the baking area for baking, performing emulsified reaction until the foaming molding, releasing the pressure handle, opening the upper cover, and taking out the finished product.

### Embodiment 2

The present embodiment provides a sole comprising a foam layer and a film layer wrapped around an outer surface of the foam layer, the film layer has a thickness of 0.09 mm; the foam layer is prepared from the following raw material, the raw material comprises material A and material B, the material A comprises, in parts by weight: 91.8% of polyester polyol mixture; 5% of chain extender; 0.2% of active polyether modified silicone oil and 3% of dicyandiamide; the material B comprises, in parts by weight: 75% of MDI; 5% of liquefied MDI; 10% of polyester polyol and 10% of polyether polyol; the raw material of the film layer comprises, in parts by weight: 60% of polyurethane resin, 10% of toner and 30% of diluents fast drying water. The raw material used in this embodiment is purchased from Laiyang Shengbang Chemical Co., Ltd.

The method for preparing a sole comprises the steps of:

(1) cleaning the mold and cleaning the mold from the inside to the outside;

(2) spraying the release agent, after mixing and diluting an aqueous release agent prepared by mixing 95 wt % of silicon germanium resin emulsion with 5 wt % of water with water at a weight ratio of 15:100, spraying the inner surface of the mold; then drying the release agent, and then wiping the surface with a clean cloth to form the inner surface of the mold of the sprayed release agent;

(3) spraying the mold, immediately spraying the uniformly mixed raw material of the film layer to the inner surface of the mold of the sprayed release agent formed in the step (2), and naturally forming a mold after mixing and drying the raw material; adjusting the spray gun into an atomizing shape when spraying, the spray gun mouth being aligned with the upper mold and the lower mold of the mold and spraying uniformly at a distance of 20 cm from the mold along the shape of the mold so that every corner of the mold can be uniformly sprayed;

(4) injecting the raw material, adding a front stage catalyst, a latter stage catalyst, water and a hardener in the material A first to be uniformly mixed to form mixed material A, adding the mixed material A in the A material cylinder for heat preservation at 38° C., adding the material B directly in the B material cylinder for heat preservation at 40° C., after uniformly mixing the material A and the material B at a weight ratio of 100:100, the mixing time is 0.3 seconds; according to different weights of yardage of each mold, filling material according to the key in which different durations of material filling are set on the filling machine correspondingly, wherein the time from the start of mixing of the material A and the material B to the discharge from the discharging port is 0.8 seconds; prior to the injection, adding a mold foot to the toe cap of the mold to be raised by 5 cm, wherein the material is filled in such a way that the material is taken from the middle of the cavity of the lower mold of the shoe mold and is fed to the toe cap along the center line of the cavity of the mold, the volume of the raw material after being injected accounts for about ⅓ of the volume of the mold cavity, while the material is injected, material is fed in the mold and the raw material injected into the mold is uniformly coated on the bottom and the periphery of the upper cavity and the lower cavity with a brush to cover the entire surface of the cavity of the mold;

(5) shaking the mold, covering the upper cover of the mold gently and quickly, and locking the mold with a pressure handle; then inverting and placing statically the mold for 2 seconds so that the raw material injected in the lower mold flows to the upper mold and then returns to position; and the toe cap of the mold facing upwards so as to form 90° with the horizontal plane for inversion of 4 seconds and then returning to position;

(6) baking, putting the mold shaken in the step (5) into the baking area for baking, performing emulsified reaction until the foaming molding, releasing the pressure handle, opening the upper cover, and taking out the finished product.

### Embodiment 3

The present embodiment provides a sole comprising a foam layer and a film layer wrapped around an outer surface of the foam layer, the film layer has a thickness of 0.05 mm; the foam layer is prepared from the following raw material, the raw material comprises material A and material B, the material A comprises, in parts by weight: 90% of polyester polyol mixture; 8% of chain extender; 0.8% of active polyether modified silicone oil and 1.2% of dicyandiamide; the material B comprises, in parts by weight: 50% of MDI; 10% of liquefied MDI; 20% of polyester polyol and 20% of polyether polyol; the raw material of the film layer comprises, in parts by weight: 60% of polyurethane resin, 10% of toner and 30% of diluents fast drying water.

The method for preparing a sole comprises the steps of:

(1) cleaning the mold and cleaning the mold from the inside to the outside;

(2) spraying the release agent, after mixing and diluting an aqueous release agent prepared by mixing 95 wt % of silicon germanium resin emulsion with 5 wt % of water with water at a weight ratio of 15:100, spraying the inner surface of the mold; then drying the release agent, and then wiping the surface with a clean cloth to form the inner surface of the mold of the sprayed release agent;

(3) spraying the mold, immediately spraying the uniformly mixed raw material of the film layer to the inner surface of the mold of the sprayed release agent formed in the step (2), and naturally forming a mold after mixing and drying the raw material; adjusting the spray gun into an atomizing shape when spraying, the spray gun mouth being aligned with the upper mold and the lower mold of the mold and spraying uniformly at a distance of 15 cm from the mold along the shape of the mold so that every corner of the mold can be uniformly sprayed;

(4) injecting the raw material, adding a front stage catalyst, a latter stage catalyst, water and a hardener in the material A first to be uniformly mixed to form mixed material A, adding the mixed material A in the A material cylinder for heat preservation at 38° C., adding the material B directly in the B material cylinder for heat preservation at 40° C., after uniformly mixing the material A and the material B by a filling machine at a weight ratio of 100:100, the mixing time is 0.5 seconds; according to different weights of yardage of each mold, filling material according to the key in which different durations of material filling are set on the filling machine correspondingly, wherein the time from the start of mixing of the material A and the material B to the discharge from the discharging port is 0.7 seconds; prior to the injection, adding a mold foot to the toe cap of the mold to be raised by 10 cm, wherein the material is filled in such a way that the material is taken from the middle of the cavity of the lower mold of the shoe mold and is fed to the toe cap along the center line of the cavity of the mold, the volume of the raw material after being injected accounts for about ½ of the volume of the mold cavity, while the material is injected, material is fed in the mold and the raw material injected into the mold is uniformly coated on the bottom and the periphery of the upper cavity and the lower cavity with a brush to cover the entire surface of the cavity of the mold; the front stage catalyst, the latter stage catalyst, and the hardener are all purchased from Xuchuan Chemical Co., Ltd;

(5) shaking the mold, covering the upper cover of the mold gently and quickly, and locking the mold with a pressure handle; then inverting and placing statically the mold for 2 seconds so that the raw material injected in the lower mold flows to the upper mold and then returns to position; and the toe cap of the mold facing upwards so as to form 90° with the horizontal plane for inversion of 4 seconds and then returning to position;

(6) baking, putting the mold shaken in the step (5) into the baking area for baking at 90° for 6 minutes, performing emulsified reaction until the foaming molding, releasing the pressure handle, opening the upper cover, and taking out the finished product.

### Embodiment 4

The present embodiment provides a sole comprising a foam layer and a film layer wrapped around an outer surface of the foam layer, the film layer has a thickness of 0.08 mm; the foam layer is prepared from the following raw material, the raw material comprises material A and material B, the material A comprises, in parts by weight: 90% of polyester polyol mixture; 8% of chain extender; 0.8% of active polyether modified silicone oil and 1.2% of dicyandiamide; the material B comprises, in parts by weight: 50% of MDI; 10% of liquefied MDI; 20% of polyester polyol and 20% of polyether polyol; the raw material of the film layer comprises, in parts by weight: 60% of polyurethane resin, 10% of toner and 30% of diluents fast drying water.

The method for preparing a sole comprises the steps of:

(1) cleaning the mold, cleaning the flash on the edge of the mold with a special scraper knife, and then blowing the foreign matter in the mold with a blower gun;

(2) spraying the release agent, after mixing and diluting an aqueous release agent prepared by mixing 95 wt % of silicon germanium resin emulsion with 5 wt % of water with water at a weight ratio of 15:100, filling the distributed aqueous release agent in a mixing tank so that the release agent and water have consistent mixing ratio and are not stratified, adjusting the spray gun into an atomizing shape, aligning the spray gun mouth with the upper mold and the lower mold of the mold and uniformly spraying a proper amount of aqueous release agent at a distance of 15 cm from the mold along the shape of the mold, and spraying every corner of the mold so that all the positions on the surface of the mold are uniformly covered with a layer of release agents having a thickness of 0.08 mm; drying excess water drops generated in the mold due to spraying the release agent using a high-pressure gas pipe in which there must be no residues, otherwise, there will be hydrolysis phenomenon in the sole; after blowing, checking whether the mold is clean or there are residual small water drops again, and wiping it with a white rag, so that it is easy for the solvent inside the release agent to dry. If the release agent is sprayed too thickly, the solvent is not volatile, and it is not easy for the release agent to dry, which will damage the product and cause the surface of the product to be rotten; therefore, the release agent must be kept dry before entering the next process;

(3) spraying the mold, immediately spraying the uniformly mixed raw material of the film layer to the inner surface of the mold of the sprayed release agent formed in the step (2), and naturally forming a mold after mixing and drying the raw material; filling the raw material in a mixing tank for stirring in order to prevent the raw material from being stratified, and then spraying the material onto the mold with a spray gun; adjusting the spray gun into an atomizing shape, the spray gun mouth being aligned with the upper mold and the lower mold of the mold and spraying uniformly at a distance of 20 cm from the mold along the shape of the mold so that every corner of the mold can be uniformly sprayed; wherein the main purpose of spraying the mold is to form a film on the surface of the mold so that this film covers the outside of the product, shielding the pinholes and current ripples generated by the surface of the product, increasing the yield rate and reducing the cost. When spraying, the film has a thickness of 0.1 mm so as to form a film, so that it is easy for the inside solvent to dry. If the film is sprayed too thickly, the solvent is not volatile, and it is not easy for the film to dry, which will damage the product and cause the surface of the product to be rotten; therefore, the film must be kept completely dry before entering the next process;

(4) injecting the raw material, using 33.3% of tertiary amines and 66.6% of ethylene glycol to prepare a front stage catalyst, mixing 90% of tertiary amines and 10% of ethylene glycol to form a late stage catalyst, adding a front stage catalyst, a latter stage catalyst, water and a hardener in the material A first to be uniformly mixed to form mixed material A, adding the mixed material A in the A material cylinder for heat preservation at 38° C., adding the material B directly in the B material cylinder for heat preservation at 40° C., after uniformly mixing the material A and the material B by a filling machine at a weight ratio of 100:100, the mixing time is 0.5 seconds; according to different weights of yardage of each mold, filling material according to the key in which different durations of material filling are set on the filling machine correspondingly, wherein the time from the start of mixing of the material A and the material B to the discharge from the discharging port is 0.7 seconds; in order to reduce the pinholes on the surface of the product, prior to the injection, adding a mold foot to the toe cap of the mold to be raised by 10 cm, wherein the material is filled in such a way that the material is taken from the middle of the cavity of the lower mold of the shoe mold and is fed to the toe cap along the center line of the cavity of the mold, the volume of the raw material after being injected accounts for about ½ of the volume of the mold cavity, while the material is injected, material is fed in the mold and the raw material injected into the mold is uniformly coated on the bottom and the periphery of the upper cavity and the lower cavity with a brush to cover the entire surface of the cavity of the mold;

(5) shaking the mold, after injecting the raw materials, covering the upper cover of the mold gently and quickly, and locking the mold with a pressure handle; then inverting the mold by 180°, so that the upper mold and the lower mold are inverted with quickly coordinated movement, placing statically the mold for 1-2 seconds so that the raw material injected in the lower mold flows to the upper mold and returns to position in order to reduce the shortage of materials and dark bubbles in the product; and the toe cap of the mold facing upwards so as to form 90° with the heel for inversion of 3-4 seconds and then returning to position in order to reduce the amount of bubbles in the product;

(6) baking, putting the mold shaken in the step (5) into the baking area for baking at 80° for 7 minutes, performing emulsified reaction until the foaming molding, after the mold is shaped by the oven, releasing the pressure handle by a professional using a crowbar, gently opening the upper cover of the mold; gently taking out the product by people who take out the product by hand along the front end of the product, making sure that the hand is clean when taking out the product without soiling the product, and then putting the product on the special product workbench.

The above is only the specific embodiment of the present invention, but the scope of protection of the present invention is not limited thereto. Any changes or substitutions conceivable by those skilled in the art should be covered within the technical scope of the present invention. It should be covered by the scope of protection of the present invention. Therefore, the scope of protection of the present invention shall be subject to the scope of protection of the appended claims.

What is claimed is:

1. A sole, wherein the sole comprises a foam layer and a film layer wrapped around an outer surface of the foam layer, the film layer has a thickness of 0.05-0.15 mm; the foam layer is prepared from the following raw material, the raw material comprises material A and material B, the material A comprises, in parts by weight: 90-95% of polyester polyol mixture; 5-10% of chain extender; 0.2-0.8% of foam stabilizer and 1-3% of foaming agent; the material B comprises, in parts by weight: 50-75% of MDI; 5-10% of liquefied MDI; 10-30% of polyester polyol and 10-20% of polyether polyol.

2. The sole according to claim 1, wherein the foam stabilizer is active polyether modified silicone oil; and the foaming agent is dicyandiamide.

3. The sole according to claim 1, wherein the raw material of the film layer comprises a polyurethane resin, a toner and fast drying water, and the film layer has a thickness of 0.1 mm

4. A method for preparing a sole according to claim 1, wherein the method comprises the steps of:
(1) cleaning the mold and cleaning the mold from the inside to the outside;
(2) spraying the release agent, after mixing and diluting an aqueous release agent with water, spraying the inner surface of the mold; then drying the release agent, and then wiping the surface with a clean cloth to form the inner surface of the mold of the sprayed release agent;
(3) spraying the mold, spraying the mixed raw material of the film layer to the inner surface of the mold of the sprayed release agent formed in the step (2), and naturally forming a mold after mixing and drying the raw material;
(4) injecting the raw material, uniformly mixing the material A and the material B of the foam layer by a filling machine according to a set ratio, and then injecting it into the mold;
(5) shaking the mold, covering the upper cover of the mold gently and quickly, and locking the mold with a pressure handle; and then gently shaking the mold so that the raw material uniformly covers the inner cavity of the mold;
(6) baking, putting the mold shaken in the step (5) into the baking area for baking, performing emulsified reaction until the foaming molding, releasing the pressure handle, opening the upper cover, and taking out the finished product for trimming.

5. The method for preparing a sole according to claim 4, wherein in the step (2), the aqueous release agent is a mixture of 95 wt % of silicon germanium resin emulsion and 5 wt % of water.

6. The method for preparing a sole according to claim 4, wherein in the step (2), the ratio of the added amount of the aqueous release agent to the water is 15:100, and the dried aqueous release agent has a thickness of 0.05-0.1 mm.

7. The method for preparing a sole according to claim 4, wherein in the step (4), prior to the injection, a mold foot is added to the toe cap of the mold to be raised by 5-10 cm, and the volume of the raw material after being injected accounts for about ⅓-½ of the volume of the mold cavity.

8. The method for preparing a sole according to claim 4, wherein in the step (4), after being uniformly mixed by a filling machine according to a set ratio, the material A and the material B of the foam layer are injected into the mold; according to different weights of yardage of each mold, material is filled according to the key in which different durations of material filling are set on the filling machine correspondingly, wherein the material is filled in such a way that the material is taken from the middle of the cavity of the lower mold of the shoe mold and is fed to the toe cap along the center line of the cavity of the mold; while the material is injected, material is fed in the mold and the raw material injected into the mold is uniformly coated on the bottom and the periphery of the upper cavity and the lower cavity with a brush to cover the entire surface of the cavity.

9. The method for preparing a sole according to claim 4, wherein in the step (4), the ratio of the added amount of the material A to the material B is 100:100, before the material A and the material B are mixed, a front stage catalyst, a latter stage catalyst, water and a hardener are added first and then are uniformly mixed to form mixed material A, and the mixed material A is kept at 38° C. for later use; and the material B is kept at 40° C.

10. The method for preparing a sole according to claim 4, wherein in the step (5), the mold is shaken in such a way as to invert the mold to the left or right by 180°, so that the lower mold and the upper cover are inverted and then placed statically for 1-2 seconds so that the material injected in the lower mold flows to the upper cover and then returns to position, and then erect the front end of the mold so that the toe cap is facing upwards and the heel is facing downwards so as to form 90° with the horizontal plane for 3-4 seconds, so that the raw material injected to the toe cap flows to the heel and then returns to position.
